(19) United States
(12) Patent Application Publication
(10) Pub. No.: US 2006/0189788 A1
(43) Pub. Date: Aug. 24, 2006

(54) Cyclic ether copolymer, coating resin composition, optical devices, and process for production of the devices

(76) Inventors: Takayuki Araki, Settsu-shi (JP); Yoshito Tanaka, Settsu-shi (JP); Yuzo Komatsu, Settsu-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/552,684

(22) PCT Filed: Mar. 31, 2004
(86) PCT No.: PCT/JP04/04613

§ 371 Date: Oct. 11, 2005

(30) Foreign Application Priority Data
Apr. 11, 2003 (JP) 2003-108365

(51) Int. Cl. C08G 65/34

(52) U.S. Cl. 528/425

(57) ABSTRACT

This invention provides a cyclic ether copolymer such as a cyclic ether copolymer excellent in solubility in solvents and easy to form uniform thin films therefrom. The present invention relates to a cyclic ether copolymer obtained from a 1,3-dioxole ring structure-containing compound represented by the following general formula (I) and an ethylenically unsaturated monomer: 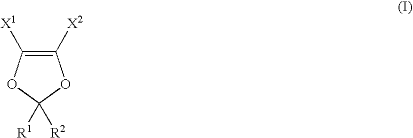
(wherein R¹ and R² are the same or different and each represents F, H, Cl or a perfluoroalkyl group containing 1 to 5 carbon atoms and X¹ and X² are the same or different and each represents F, H, Cl or —OR³, and R³ represents a perfluoroalkyl group containing 1 to 5 carbon atoms, provided that at least one of R¹ and R² is F or a perfluoroalkyl group containing 1 to 5 carbon atoms), which compolymer has a glass transition point of 100 to 135° C. and an intrinsic viscosity of 0.01 to 0.4 dl/g as determined at 35° C. in perfluoro-2-butyltetrahydrofuran.

### TECHNICAL FIELD

The present invention relates to a cyclic ether copolymer, a resin composition for coating, and an optical device.

### BACKGROUND ART

Resin-made optical materials are characterized in that they are lighter in weight as compared with inorganic optical materials and excellent in shock resistance, processability and economy, and easy to handle. Therefore, they are expected to be practically useful in manufacturing parts for optical communication, typically optical waveguides.

Known as the resin polymers so far used as optical materials are polymethyl methacrylate [PMMA], polystyrene [PS] and like C—H bond-containing polymers. However, such C—H bond-containing polymers show higher stretching vibration harmonics and bending vibration absorptions in the near infrared wavelength region and therefore have a problem in that optical losses will result when the wavelengths used in optical communication are shifted to the near infrared wavelength region in the future.

Known as noncrystalline polymers containing no C—H bonds and excellent in moisture resistance, heat resistance and optical transmissivity are perfluoro organic polymer materials having a cyclic ether structure such as perfluoro-(2,2-dimethyl-1,3-dioxole) [PDD] (cf. e.g. Japanese Kokai Publication Hei-04-190202 and Japanese Kokai Publication Hei-10-227931). Japanese Kokai Publication Hei-04-190202 discloses PDD/tetrafluoroethylene [TFE] copolymers, and these copolymers are used for the manufacture of optical waveguides. However, there are no suggestions about the monomer compositions and molecular weights of the copolymers.

Japanese Kokai Publication Hei-10-227931 discloses, in Example 1 that a PDD/TFE copolymer with a PDD copolymerization percentage of 83 mole percent or above was used as clads. However, this copolymer has a problem in that it is poorly soluble in solvents.

A PDD/TFE copolymer with a PDD copolymerization percentage of 56.9 mole percent has also been disclosed (cf. e.g. Japanese Kokai Publication Sho-58-38707). However, there is no disclosure about the use of the PDD/TFE copolymer disclosed in Japanese Kokai Publication Sho-58-38707 as a coating resulting from dissolution in a solvent or about the use thereof as an optical material.

Further, in Japanese Kokai Publication Sho-58-38707, the apparent melt viscosity [AMV] roughly estimated from the melt flow rate [MFR] value obtained at 230° C. under a load of 383.1 g according to ASTM D 2116 by calculation based on the formula:
AMV (pascal·sec)=6.4×load (g)/MFR (g/10 min)
indicates a molecular weight as high as 900 or 1650. Thus, the PDD/TFE copolymer has problems with respect to solubility in solvents and film-forming ability.

A resin composition for coating which comprises dissolving a PDD/TFE copolymer having an intrinsic viscosity of 0.05 to 0.35 dl/g has been disclosed (cf. e.g. Japanese Kokai Publication Hei-03-252474). Although this document describes that the copolymerization percentage of the ring structure-forming monomer unit in the polymer is preferably not lower than 40 mole percent, it has no suggestion concerning the improvement in solubility in solvents or the improvement in applicability in the coating step.

### SUMMARY OF THE INVENTION

In view of the above-discussed state of the art, it is an object of the present invention to provide a cyclic ether copolymer such as a cyclic ether copolymer excellent in solubility in solvents and easy to form uniform thin films therefrom.

The present invention provides a cyclic ether copolymer obtained from a 1,3-dioxole ring structure-containing compound represented by the following general formula (I) and an ethylenically unsaturated monomer: 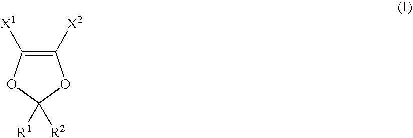
(wherein R¹ and R² are the same or different and each represents F, H, Cl or a perfluoroalkyl group containing 1 to 5 carbon atoms and X¹ and X² are the same or different and each represents F, H, Cl or —OR³, and R³ represents a perfluoroalkyl group containing 1 to 5 carbon atoms, provided that at least one of R¹ and R² is F or a perfluoroalkyl group containing 1 to 5 carbon atoms),

which compolymer has a glass transition point of 100 to 135° C. and an intrinsic viscosity of 0.01 to 0.4 dl/g as determined at 35° C. in perfluoro-2-butyltetrahydrofuran.

The present invention also provides a laminate comprising a substrate and a thin film formed on the substrate by using the above-defined cyclic ether copolymer, in which the thin film has a thickness not exceeding 1000 μm.

The present invention further provides a resin composition for coating which comprises the above-defined cyclic ether copolymer and a solvent for dissolving the cyclic ether copolymer.

The present invention further provides an optical material which comprises the above-defined cyclic ether copolymer.

The present invention further provides an optical device having an optical waveguide in which the optical waveguide has a core formed by using the above-defined optical material and/or a clad formed by using the above-defined optical material.

The present invention further provides a method of producing an optical device by using the above-defined cyclic ether copolymer, which comprises the step (1) of producing said cyclic ether copolymer, the step (2) of preparing a resin composition for coating by using said cyclic ether copolymer and a solvent for dissolving said cyclic ether copolymer, the step (3) of forming a lower clad on a substrate by using said resin composition for coating, the step (4) of forming a core on said lower clad, and the step (5) of forming an upper clad, by using said resin composition for coating, on said core obtained by said step (4) and formed on said lower clad.

### DETAILED DISCLOSURE OF THE INVENTION

In the following, the present invention is described in detail.

The cyclic ether copolymer of the present invention is obtained from a 1,3-dioxole ring structure-containing compound and an ethylenically unsaturated monomer.

The 1,3-dioxole ring structure-containing compound is an organic compound represented by the general formula (I) given above.

The term “1,3-dioxole ring structure” as used herein means the five-membered ring which 1,3-dioxole has and which is a ring structure constituted of carbon atoms and oxygen atoms. Thus, the 1,3-dioxole ring structure does not include, within the meaning thereof, any univalent atom or univalent atomic group bound to any 5-membered 1,3-dioxole ring-constituting carbon atom.

As is evident from the above general formula (I), the 1,3-dioxole ring structure-containing compound mentioned above is one in which at least one of R¹ and R² is a fluorine atom or a perfluoroalkyl group containing 1 to 5 carbon atoms. It is preferred that R¹ and R² are the same or different and each is a fluorine atom or a perfluoroalkyl group containing 1 to 5 carbon atoms. It is more preferred that R¹ and R² each is a trifluoromethyl group.

The 1,3-dioxole ring structure-containing compound is still more preferably perfluoro-(2,2-dimethyl-1,3-dioxole) [PDD] in which R¹ and R² each is a trifluoromethyl group and X¹ and X² each is a fluorine atom. The PDD has no C—H bond, hence can give cyclic ether copolymers excellent in transparency in the near infrared wavelength region.

The above-mentioned ethylenically unsaturated monomer is not particularly restricted but may be any one copolymerizable with the 1,3-dioxole ring structure-containing compound. A fluorine-containing ethylenic monomer containing 2 to 3 carbon atoms is preferably used, however. The fluorine-containing ethylenic monomer containing 2 to 3 carbon atoms is not particularly restricted but preferably is an ether bond-free fluoroolefin. As such fluoroolefin, there may be mentioned, among others, tetrafluoroethylene [TFE], chlorotrifluoroethylene [CTFE], hexafluoropropylene [HFP], vinylidene fluoride [VdF], vinyl fluoride [VF], trifluoropropene, trifluoroethylene [TrFE] and CF₂═CCl₂. Among them, TFE, CTFE, HFP, VdF and VF are preferred, and TFE and CTFE are more preferred.

The fluoroolefins mentioned above may be used singly or two or more of them may be used in combination.

The cyclic ether copolymer of the present invention is essentially a binary copolymer of the 1,3-dioxole ring structure-containing compound and the ether bond-free fluoroolefin containing 2 to 3 carbon atoms and accordingly has good transparency and good heat resistance. Furthermore, the present inventors found out, among such copolymers, cyclic ether copolymers excellent in applicability in coating.

Nevertheless, the cyclic ether copolymer of the present invention may be one resulting from subjecting a third monomer to copolymerization in addition of the 1,3-dioxole ring structure-containing compound and the ether bond-free fluoroolefin containing 2 to 3 carbon atoms, provided that the performance characteristics of the cyclic ether copolymer are not adversely affected.

Preferred as the third monomer are, for example, (1) a fluorine-containing ethylenic monomer other than the above-mentioned fluoroolefins for the purpose of controlling the mechanical physical properties and/or the heat resistance and (2) a functional group- and fluorine-containing ethylenic monomer which provides good adhesion to substrates and/or increased strength resulting from crosslinking.

(1) Fluorine-Containing Ethylenic Monomer

The fluorine-containing ethylenic monomer so referred to herein is a fluoroolefin containing 4 or more carbon atoms, which optionally contains an ether bond but has no aliphatic cyclic structure. From the viewpoint of glass transition point control or copolymerizability, the fluorine-containing ethylenic monomer in which the number of carbon atoms is within the above range may be one containing not more than 30 carbon atoms but preferably is one containing not more than 20 carbon atoms, more preferably not more than 10 carbon atoms. As the fluorine-containing ethylenic monomer, there may be mentioned, among others, the following:
CF₂═CFO(CF₂)ₙ₁F, (n1 representing an integer of 1 to 5)
CH₂═C(CF₃)₂ 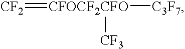 CH₂═CF(CF₂)ₙ₂Z (Z representing H,F or Cl and n2 representing an integer of 2 to 10)
CH₂═CHOCH₂(CF₂)ₙ₃Z (Z representing H,F or Cl and n3 representing an integer of 1 to 10)
These monomers are excellent in copolymerizability and are preferred because of ease of glass transition point control. In particular, those having a perfluoroalkyl group, a perfluoroalkylene group, a perfluorovinyl group and/or a perfluoromethylene group [CF₂═] are preferred from the viewpoint of transparency in the near infrared wavelength region and, as the perfluoroalkyl or perfluoroalkylene group are those containing 1 to 20 carbon atoms, more preferably 1 to 10 carbon-atoms.
(2) Functional Group- and Fluorine-Containing Ethylenic Monomer

The functional group- and fluorine-containing ethylenic monomer is preferably used since it can improve the adhesion to substrates and the blendability with such an additive as an optically functional material (e.g. material having light-amplifying function), among others, while maintaining the transparency of the cyclic ether copolymer in the near infrared wavelength region. In addition, such monomer is preferred because of its ability to providing such a function as crosslinkability.

As the functional group, particularly preferred is an adhesive function group having an ability to bond to substrates.

The functional group is preferably one which will not significantly influence the transparency to light in the near infrared wavelength region used in optical communication and comprises, for example, at least one organic group selected from the group consisting of —OH, —SO₃H, sulfonic acid group derivatives, an epoxy group, a cyano group, —COOH and carboxyl group derivatives.

As the sulfonic acid derivatives, there may be mentioned —SO₂X (X representing a halogen atom), an aminosulfonyl group, and a sulfonic acid group in a salt form, among others. As the carboxyl group derivatives, there may be mentioned —COOR⁴ (R⁴ representing an alkyl group containing 1 to 6 carbon atoms), and a carboxyl group in a salt form, among others.

As the salt among the sulfonic acid group derivatives and as the salt among the carboxyl group derivatives, there may be mentioned, for example, quaternary ammonium salts and metal salts.

The amino group in the above-mentioned aminosulfonyl group may be substituted by an alkali metal, an alkyl group or a sulfonyl group-containing fluoroalkyl group, for instance, and the quaternary-ammonium ion constituting the above-mentioned quaternary ammonium salts may be substituted by an alkyl group containing 1 to 4 carbon atoms.

The repeating unit derived from the adhesive functional group- and fluorine-containing ethylenic monomer in the molecular structure of the polymer is not particularly restricted but may be, for example, a structural unit represented by the following general formula (II): 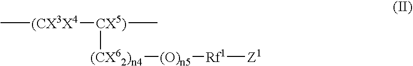
wherein X³, X⁴ and X⁵ are the same or different and each represents H or F, X⁶ represents H, F or CF₃, n⁴ represents an integer of 0 to 2, n⁵ represents 0 or 1, Rf¹ represents a fluoroalkylene group containing 1 to 40 carbon atoms or an ether bond-containing fluoroalkylene group containing 2 to 100 carbon atoms and Z¹ represents at least one organic group selected from the group consisting of —OH, —SO₃H, sulfonic acid group derivatives, an epoxy group, a cyano group, —COOH and carboxyl group derivatives. Preferred among others are structural units derived from
CH₂═CFCF₂ORf¹-Z¹
wherein Rf¹ and Z¹ are as defined above. As for the adhesive functional group- and fluorine-containing ethylenic monomer, there may more specifically be mentioned structural units derived from such fluorine-containing ethylenic monomers as 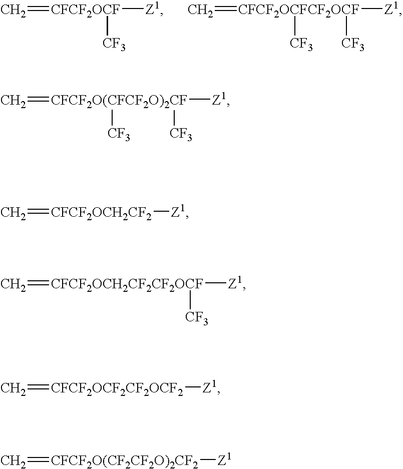
(In the above, each Z¹ is as defined above).

Structural units derived from
CF₂═CFORf¹-Z¹
wherein Rf¹ and Z¹ are as defined above, are also preferred examples. More specifically, there may be mentioned structural units derived from 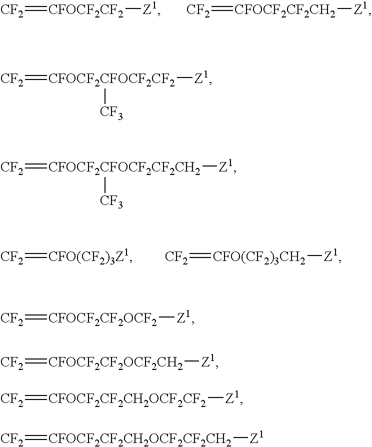
(In the above, Z¹ is as defined above.)

As the functional group- and fluorine-containing ethylenic monomer (2), there may further be mentioned
CF₂═CFCF₂—O-Rf²-Z¹, CF₂═CF-Rf²-Z¹,
CH₂═CH-Rf²-Z¹, and CH₂═CHO-Rf²-Z¹
(In the above, Z¹ is as defined above and Rf² represents a fluoroalkylene group containing 1 to 40 carbon atoms or an ether bond-containing fluoroalkylene group containing 2 to 100 carbon atoms). More specifically, there may be mentioned, among others, 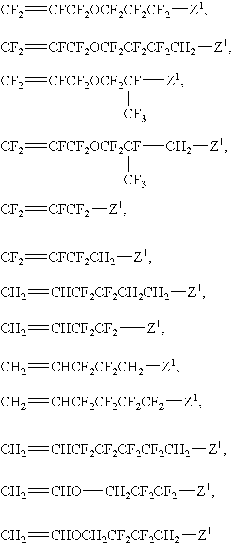
(In the above, Z¹ is as defined above).

The third monomers shown in the above (1) and (2) are examples preferred in that those monomers are excellent in copolymerizability and able to provide some novel function or other without significantly impairing the transparency in the near infrared region or the applicability of the cyclic ether copolymer of the present invention.

In cases where the cyclic ether copolymer of the present invention comprises the repeating unit derived from the third monomer mentioned above in addition to 1,3-dioxole ring structure-containing compound and one ether bond-free fluoroolefin containing 2 to 3 carbon atoms (these two hereinafter referred to as “main two elemental units”), as described above, it is preferred that the third monomer-derived repeating unit content be lower than 20 mole percent, more preferably lower than 10 mole percent, still more preferably lower than 5 mole percent, relative to all the repeating units.

The “third monomer-derived repeating unit” so referred to herein is a partial component of the molecular structure of the cyclic ether copolymer of the present invention and is a repeating unit other than the main two element units.

In cases where the cyclic ether copolymer of the present invention is a binary polymer composed of the 1,3-dioxole ring structural unit derived from the 1,3-dioxole ring structure-containing compound and the TFE unit derived from the above-mentioned TFE, it is preferred that the number of moles of the 1,3-dioxole ring structure unit be 45 to 60 mole percent relative to the sum of the number of moles of the 1,3-dioxole ring structure unit and the number of moles of the TFE unit. A more preferred lower limit is 47.5 mole percent, a still more preferred lower limit is 50 mole percent, and a particularly preferred lower limit is 55 mole percent.

The 1,3-dioxole ring structure unit and TFE unit are both constitute parts of the molecular structure of the cyclic ether copolymer of the present invention and are moieties derived from the respective corresponding monomers.

The 1,3-dioxole ring structure unit content is the value calculated from the data from F-19 nuclear magnetic resonance spectrometry [¹⁹F-NMR].

The cyclic ether copolymer of the present invention is preferably one obtained by polymerization with a carbonyl group-containing polymerization initiator, and preferably is one obtained by using the carbonyl group-containing polymerization initiator in an amount of 0.3 to 10% by mass relative to the total mass of the monomers of the cyclic ether copolymer as charged. When the amount is smaller than 0.3% by mass, the adhesion to substrates may be insufficient and, when it is above 10% by mass, the effects corresponding to the usage of the polymerization initiator will hardly be obtained. A more preferred upper limit is 8% by mass, and a still more preferred upper limit is 5% by mass. When the cyclic ether copolymer of the present invention is obtained by polymerization using the above-mentioned carbonyl group-containing polymerization initiator, it is obtained generally as one having the above-mentioned adhesive functional group at one or both of the polymer chain termini.

The cyclic ether copolymer of the present invention is preferably one having the adhesive functional group at one or both of the polymer chain termini. The polymer chain termini are generally derived from the polymerization initiator or chain transfer agent to be described later herein. It is also possible to modify the chemical structure of each polymer chain terminus by an appropriate subsequent chemical treatment.

The cyclic ether copolymer of the present invention has a glass transition point of 100° C. to 135° C. When the glass transition point is lower than 100° C., the heat resistance will be low and, for example, in the case of use as an optical device described later herein, the durability may be insufficient in certain cases and, when it is higher than 135° C., the solubility in solvents will be low, the film-forming ability will be low, and the adhesion to substrates may be poor in some cases. A preferred lower limit to the glass transition point is 105° C., a more preferred lower limit is 110° C., a still more preferred lower limit is 120° C., and a preferred upper limit is 130° C.

The above-mentioned glass transition point is the value of the midpoint of the endothermic curve obtained by differential scanning calorimetric analysis [DSC] at a temperature raising rate of 10° C./min as taken as the glass transition point.

The cyclic ether copolymer of the present invention has an intrinsic viscosity of 0.01 to 0.4 dl/g as determined at 35° C. in perfluoro-2-butyltetrahydrofuran. When that viscosity is lower than 0.01 dl/g, the coated films obtained may readily undergo cracking, hence the mechanical strength tends to be insufficient. When it is exceeding 0.4 dl/g, the film-forming ability will be low and the adhesion to substrates tends to be low. A preferred lower limit to the intrinsic viscosity is 0.05 dl/g, and a preferred upper limit is 0.3 dl/g.

The above-mentioned intrinsic viscosity is calculated from the reduced viscosity value obtained by making measurements of at least four sufficiently dilute perfluoro-2-butyltetrahydrofuran solutions differing in concentration at 35° C. using an Ubbellohde capillary viscometer.

The resin composition for coating according to the present invention comprises the above-mentioned cyclic ether copolymer and a solvent for dissolving the cyclic ether copolymer.

As the solvent for dissolving the cyclic ether copolymer, there may be mentioned perfluoro type solvents and hydrogen atom- and/or chlorine atom-containing fluorinated solvents, and one or a combination of two or more of these can be used.

The perfluoro type solvent is not particularly restricted but includes, among others, perfluorobenzene, perfluoro(2-butyltetrahydrofuran), perfluorotrialkylamines N(CₙF₂ₙ₊₁)₃ (in the formula, n representing an integer of 2 to 4), perfluoroalkanes CₙF₂ₙ₊₂ (in the formula, n representing an integer of 6 to 8), perfluorocycloalkanes, perfluoroalkenes, perfluoro cyclic ethers, hexafluoropropylene oligomers, perfluorodecalin and perfluoro-N-methylmorpholine and, among them, perfluoro-(2-butyltetrahydrofuran) and perfluorotrialkylamines represented by the following general formula (III):
N(CₙF₂ₙ₊₁)₃
(wherein n represents an integer of 2 to 4) are preferred from the film-forming ability viewpoint.

The above-mentioned hydrogen atom- and/or chlorine atom-containing fluorinated solvent is not particularly restricted but includes, among others, a mixture of
CF₃CF₂CHCl₂ and CClF₂CF₂CHClF [HCFC-225];
CCl₂FCClF₂ [CFC-113];
CH₃CCl₂F [HCFC-141B];
fluorine- and chlorine-containing perhaloalkanes represented by the following general formula:
F(CFClCF₂)ₙ₆Cl (in which n6 represents an integer of 1 to 7);
mixtures of CF₃CClFCClFCF₃ and CClF₂CClFCF₂CF₃; H(CF₂CF₂)₂Cl;
fluorine-containing ethers represented by the following general formula (IV):
R⁵—O—R⁶
(wherein R⁵ is a straight or branched polyfluoroalkyl group containing 1 to 12, preferably 3 to 12 carbon atoms, which optionally contains an ether bond, and R⁶ is a straight or branched alkyl group containing 1 to 12, preferably 1 to 3 carbon atoms); and
fluorine-containing alcohols represented by the following general formula:
H(CF₂CF₂)ₙ₇CH₂OH (n7 representing an integer of 1 to 3),
F(CF₂)ₙ₈CH₂OH (n8 representing an integer of 1 to 5), or
CF₃CH(CF₃)OH.

As specific examples of the fluorine-containing ethers represented by the above-mentioned general formula (IV), there may be mentioned, for example:
CHF₃CF₂OCF₃, CF₃CF₂CF₂OCH₃, CF₃CFHCF₂OCH₃, C₄H₉OCH₃,
(CF₃)₂CHCF₂OCH₃, C₄H₉OCH₂CH₃ and CHF₂CF₂CF₂CF₂CH₂OCH₃.

Among the hydrogen atom- and/or chlorine atom-containing fluorinated solvents mentioned above, HCFC-225, fluorine- and chlorine-containing perhaloalkanes represented by the following general formula:
F(CFClCF₂)ₙ₉Cl
(wherein n9 represents an integer of 1 to 7), C₄F₉OCH₃ and the like are preferred from the film-forming ability viewpoint.

The cyclic ether copolymer of the present invention is improved in solubility in solvents and therefore can be solubilized even in those solvents in which the prior art copolymers are insoluble or soluble only to an unsatisfactory extent. More specifically, it can be solubilized in HCFC-225, CFC-113, those perfluorotrialkylamines represented by the above general formula (III), those fluorine-containing ethers represented by the above general formula (IV) and the like in which the prior art 1,3-dioxole ring structure-containing compound copolymers cannot be solubilized.

Preferably used as the solvent for dissolving the above-mentioned cyclic ether copolymer are the hydrogen atom- and/or chlorine atom-containing fluorinated solvents rather than the perfluoro solvents since they are low in volatility and hardly causes rippling (surface waviness) in the step of film formation.

The solvent for dissolving the above-mentioned cyclic ether copolymer is preferably a solvent comprising at least one member selected from the group consisting of perfluoro-2-butyltetrahydrofuran, HCFC-225, CFC-113, the perfluorotrialkylamines represented by the above general formula (III) and the fluorine-containing ethers represented by the above general formula (IV).

In cases where the solvent for dissolving the cyclic ether copolymer comprises a combination of two or more species, the combined use of a high-boiling solvent and a low-boiling solvent is preferred.

Preferred as the combination of a high-boiling solvent and a low-boiling solvent is the combination of HCFC-225 and a perfluorotrialkylamine N(CₙF₂ₙ₊₁)₃ (in which n represents an integer of 2 to 4) or the combination of perfluoro-2-butyltetrahydrofuran and a perfluorotrialkylamine N (CₙF₂ₙ₊₁)₃ (in which n represents an integer of 2 to 4). More preferred is the combination of perfluoro-2-butyltetrahydrofuran and a perfluorotributylamine N(C₄F₉)₃.

The cyclic ether copolymer of the present invention is superior in solubility in those solvents for dissolving the cyclic ether copolymer as compared with the conventional copolymers obtained from a 1,3-dioxole ring structure-containing compound and an ethylenically unsaturated monomer and by increasing the amount dissolved in the conventional solvents for dissolving copolymers, thus, the copolymer not only makes it possible to obtain high-concentration coating compositions according to the intended use but can be dissolved in HCFC-225 not capable of dissolving copolymers in the prior art.

A non-fluorinated solvent may further be added to the above solvent at levels that will not cause any substantial decrease in solubility. The non-fluorinated solvent is not particularly restricted but includes, among others, cellosolve type solvents such as methyl cellosolve, ethyl cellosolve, methyl cellosolve acetate and ethyl cellosolve acetate; ester type solvents such as diethyl oxalate, ethyl pyruvate, ethyl 2-hydroxybutyrate, ethyl acetoacetate, butylacetate, amyl acetate, ethyl butyrate, butyl butyrate, methyl lactate, ethyl lactate, methyl 3-methoxypropionate, ethyl 3-methoxypropionate, methyl 2-hydroxyisobutyrate and ethyl 2-hydroxyisobutyrate; propylene glycol type solvents such as propylene glycol monomethyl ether, propylene glycol monoethyl ether, propylene glycol monobutyl ether, propylene glycol monomethyl ether acetate, propylene glycol monoethyl ether acetate, propylene glycol monobutyl ether acetate, dipropylene glycol dimethyl ether; ketone type solvents such as 2-hexanone, cyclohexanone, methyl amino ketone and 2-heptanone; alcohol type solvents such as methanol, ethanol, propanol, isopropanol and butanol; aromatic hydrocarbons such as toluene and xylene; and mixed solvents composed of these. Among them, ester type solvents are preferred from the viewpoint of improvement in film-forming ability.

The concentration of the cyclic ether copolymer of the present invention relative to the total mass of the resin composition for coating according to the present invention is preferably 0.1 to 50% by mass. When it is below 0.1% by mass, the productivity in manufacturing coated articles tends to decrease and, when it is above 50% by mass, the film-forming ability in forming films by coating tends to lower. A more preferred lower limit is 1% by mass, a still more preferred lower limit is 5% by mass and a particularly preferred lower limit is 7% by mass while a more preferred upper limit is 30% by mass, a still more preferred upper limit is 20% by mass and a particularly preferred upper limit is 15% by mass.

The resin composition for coating according to the present invention may contain an additive. The additive is not particularly restricted but includes, among others, refractive index modifiers, antioxidants, UV stabilizers, leveling agents, viscosity modifiers, light stabilizers, moisture absorbers, pigments, dyes and reinforcing agents.

The resin composition for coating according to the present invention can be prepared so as to have a high concentration according to the intended use, and the range of the solvents capable of dissolving it is wider as compared with the prior art. Therefore, the composition can be adequately used in those fields where the properties, in particular the transparency in the near infrared wavelength region, of the cyclic ether copolymer is made the most of.

The laminate of the present invention comprises a substrate and a thin film formed on the substrate by using the above-described cyclic ether copolymer.

The laminate of the present invention can be excellent in adhesion to substrates; a laminate showing a small percentage of peeling in a cross cut test carried out according to JIS K 5400 6.15, for instance, can be obtained. The laminate of the present invention may comprise a kind of the cyclic ether copolymer having an adhesive terminus to be described later herein, hence the laminate can be excellent in adhesion to substrates. If the adhesion is poor, the thin film may unfavorably be peeled off from the substrate, for example in the step of dicing in which optical integrated circuits formed on a silicon wafer is cut crosswise according to the chip size.

The material of the substrate is not particularly restricted but includes, among others, silicon; metals such as aluminum, aluminum alloys, silver, gold, platinum, nickel, copper and titanium; glass; and resins such as polyimide resins, polyethylene terephthalate resins, acrylic resins and polycarbonate resins. The substrate is not particularly restricted but includes, among others, substrates for forming optical devices such as optical circuits and, from the multiple use viewpoint, silicon wafers are preferred. The substrate may be one appropriately subjected to such treatment as plasma treatment or ozone treatment or coating with a primer such as a silane coupling agent for the improvement in adhesion.

The method of producing the laminate of the present invention is not particularly restricted but there may be mentioned, for example, the method comprising applying the above-mentioned resin composition for coating to the substrate for the formation of a thin film, the method comprising preparing in advance a film, preferably a cast film, made of the above-mentioned cyclic ether copolymer and covering the substrate with the film, the method comprising; applying a powder coating comprising the cyclic ether copolymer to the substrate and then baking the same for the formation of a thin film, and the method comprising forming a thin film of the cyclic ether copolymer directly on the substrate by the vapor deposition method. From the thin film leveling viewpoint, the method which uses the resin composition for coating is preferred.

The thin film preferably has a thickness not exceeding 1000 μm, more preferably not exceeding 100 μm. A preferred lower limit to the thin film thickness may be set at 20 nm, for instance, provided that the thickness is within the above range.

The laminate of the present invention is a laminate comprising the above-mentioned substrate and a thin film formed on the substrate by using the above-mentioned cyclic ether copolymer, and the thin film preferably has a film thickness not exceeding 1000 μm and, when subjected to a cross cut test, preferably gives a peel rate of not higher than 50/100. When the rate exceeds 50/100, the thin film is frequently peeled off from the substrate, for example, in the step of dicing in which optical integrated circuits formed on a silicon wafer is cut crosswise according to the chip size; this is unfavorable from the practical viewpoint. The peel rate is more preferably not higher than 40/100, still more preferably not higher than 30/100.

The laminate of the present invention is excellent in the adhesion between the substrate and the cyclic ether copolymer-based thin film and, when the laminate obtained is cut to an appropriate size, for instance, an effect is obtained such that the thin film is hardly peeled off from the substrate. The mechanism by which such effect is produced is not clear but may by considered as follows.

Thus, since the cyclic ether copolymer has an intrinsic viscosity within the above-defined range, it is understood that the copolymer is relatively low in molecular weight. And, since it is a low-molecular-weight polymer, it has a relative large number of polymer chain termini per unit weight of the polymer and, in addition, the polymer chain termini can be adhesive termini to be described later herein and, therefore, it is excellent in adhesion to the substrate.

The use of the laminate of the present invention is not particularly restricted but the laminate can be appropriately used, for example, in those fields of application where the properties, in particular the transparency in the near infrared wavelength region, of the cyclic ether copolymer are made the best of. As such fields of use, there may be mentioned, for example, those optical filters, condenser lenses, antireflection agents and refractive index modifiers which are to be used in the near infrared wavelength region.

The cyclic ether copolymer of the present invention can be adequately used not only in forming the above-mentioned laminate but also as an optical material.

The optical material is to serve as a material for the manufacture of those optical devices to be described later herein. It may occur as a powder or, like the resin composition for coating according to the present invention, a solution in a solvent, or a film or a like molded article having a primitive shape or form.

The optical material is not particularly restricted but is useful, for example, as a material for an optical waveguide or a like optical material for optical devices, as a material for sealing members necessary for the processing of optical devices, as a lens material, or as a light-emitting devices and, further, as an optical material for display devices such as antireflection films.

Here, for optical devices, the optical material may be used for optical amplifier devices, optical switches, light filters, optic branching devices, wavelength converting devices, and other arbitrary devices. Further, optical circuits resulting from combination of an optic branching device, including an N branching waveguide (N being an integer of at least 2), with the above-mentioned device will be very useful in the future advanced information communication society. These devices can be utilized in combination in constructing optical rooters, ONUs, OADMs, media converters and so forth.

The type of the optical waveguide devices can be properly selected according to the intended use of the devices from among the planar, strip, ridge, embedded and other types.

As the light-emitting devices, there may be mentioned, among others, EL devices, polymer light-emitting diodes, light-emitting diodes, optical fiber lasers, laser elements, optical fibers, liquid crystal backlights, and photodetectors. These are applied in large-sized displays, illumination, liquid crystals, optical disks, laser printers, medical lasers, laser processing, printing, copying machines and so forth.

As for the lens material, there may be mentioned pickup lenses, lenses for spectacles, camera lenses, Fresnel lenses for projectors, contact lenses, etc.

As regards the sealing member material necessary for the manufacture of optical devices, there may be mentioned, for example, packaging (sealing) and surface mounting of optically functional devices such as light-emitting diodes (LEDs), EL devices, nonlinear optical devices and other light-emitting or light-receiving devices. The sealed optical devices are used in various places and, as nonlimitative examples, there may be mentioned light-emitting devices as sources of light for high mounted stop lamps, meter panels, cellular phone backlights, remote control devices in various electric appliances; and light-receiving devices for autofocus cameras and for optical pickups of CD/DVD players, among others.

The copolymer is also useful as a matrix polymer in color rendering materials for white LEDs.

As for the optical material for display devices, there may be mentioned antireflection materials, covering materials for lighting apparatus, display protecting sheets, transparent cases, display boards, automotive parts, etc.

The material can also be used in producing optical disk substrates.

The optical material of the present invention has a high glass transition point-and therefore can be used as a material of heat-resistant optical transmission media or as a core and/or clad material of plastic optical fibers comprising a core and a clad.

The plastic optical fibers produced by using the optical material of the present invention are highly resistant to heat and therefore are useful in cases where heat resistance is required at 100° C. or above. In the case of light guides, for instance, such heat resistance is required when plastic optical fibers are laid in the vicinity of halogen light sources. In the case of sensors, heat resistance is required in detecting sites where the atmosphere reaches a high temperature, for example in detecting headlight illumination of cars or in the case of melt press positioning sensors, for instance. The situation is the same with sensors in industrial robots. In the field of optical communications, for example in onboard LANs, heat resistance at 100° C. and above is required in the case of wiring within the engine room or on the car ceiling or installed panel, for instance, where the temperature rises to high levels. In the case of mounting on airplanes, too, the situation is the same. As regards plastic optical fiber wiring in the field of factory automation (FA), too, heat resistance is required when the wiring systems are exposed to a high-temperature environment. Further, in the case of outdoor use or even in the case of indoor use in such an environment that there is no ordinary air conditioning equipment in the panel room or communication base station on the roof of a building, heat resistance is required. The optical material of the present invention can be effectively utilized in such use environments.

The optical device of the present invention is an optical device having an optical waveguide, and the optical waveguide has a core formed by using the above-mentioned optical material of the present invention and/or a clad formed by using the above-mentioned optical material.

In the above-mentioned optical device, the core may be one merely having optical transmissivity or, further, may be one having some function according to the intended use. The core must have a refractive index higher than the refractive index of the clad, and the difference in refractive index between the core and clad is preferably not smaller than 0.001, more preferably not smaller than 0.003. The core in the optical device of the present invention is not particularly restricted but may be made of such a polymer material as an epoxy resin, acrylic resin, silicone resin, polyimide resin or cyclic amorphous fluororesin, for instance, and preferred is a fluoropolymer material resulting from substitution of fluorine atoms for part or all of the hydrogen atoms from the viewpoint of transparency in the near infrared wavelength region.

The above-mentioned cyclic amorphous fluororesin is not particularly restricted but includes, among others, those having, within the molecular structure thereof, such an repeating unit(s) as 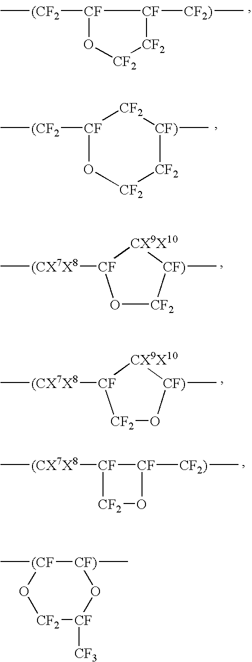
(wherein X⁷, X⁸, X⁹ and X¹⁰ are the same or different and each represents H or F), 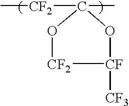
and/or the like.

Also usable as the core in the above optical device is a composition resulting from addition of a dopant for increasing the refractive index to the above-mentioned cyclic ether copolymer. The dopant is not particularly restricted but, for example, benzyl n-butyl phthalate (refractive index: 1.575), 1-methoxyphenyl-1-phenylethane (refractive index: 1.571), benzyl benzoate (refractive index: 1.568), bromobenzene (refractive index: 1.557), o-dichlorobenzene (refractive index: 1.551), m-dichlorobenzene (refractive index: 1.543), 1,2′-dibromoethane (refractive index: 1.538), 3-phenyl-1-propanol (refractive index: 1.532), diphenyl phthalate (C₆H₄(COOC₆H₅)₂), triphenylphosphine ((C₆H₅)₃P) and dibenzyl phosphate ((C₆H₅CH₂O)₂PHO₂), 4,4′-dibromobenzil, 4,4′-dibromobiphenyl, 2,4′-dibromoacetophenone, 3′,4′-dichloroacetophenone, 3,4-dichloroaniline, 2,4-dibromoaniline, 2,6-dibromoaniline, 1,4-dibromobenzene or a like low-molecular-weight compound can be added.

The low-molecular-weight compound not only simply and uniformly modifies the refractive index of the optical material of the present invention but also functions as a dopant for producing a refractive index distribution (graded index) type optical fiber described in Japanese Kokai Publication Hei-08-110420. The optical material of the present invention also serves as a material useful in obtaining a heat-resistant refractive index distribution (graded index) type optical fiber.

As regards the dopant, halogenated aromatic hydrocarbons having no carbon-bound hydrogen atoms can also be used as refractive index modifiers. In particular, halogenated aromatic hydrocarbons containing fluorine atoms alone as the halogen atoms as well as halogenated aromatic hydrocarbons containing fluorine and other halogen atoms are preferred from the viewpoint of compatibility with the fluoropolymer.

As the halogenated aromatic hydrocarbons, there are, for example, compounds represented by the formula Φ-Zb (in which Φ represents a perfluoro aromatic ring residue with a valence of b and Z represents a halogen atom other than fluorine, -Rf³, —CORf³, —ORf³ or CN; Rf³ represents a perfluoroalkyl group, a perhalopolyfluoroalkyl group or a monovalent Φ; b represents an integer of not smaller than 0). The aromatic ring is a benzene ring or naphthalene ring. The perfluoroalkyl group or perhalopolyfluoroalkyl group Rf³ preferably contains not more than 5 carbon atoms. Chlorine and/or bromine atoms are preferred as the halogen atoms other than fluorine.

The above-mentioned halogenated aromatic hydrocarbons are not particularly restricted but include, among others, 1,3-dibromotetrafluorobenzene, 1,4-dibromotetrafluorobenzene, 2-bromotetrafluorobenzotrifluoride, chloropentafluorobenzene, bromopentafluorobenzene, iodopentafluorobenzene, decafluorobenzophenone, perfluoroacetophenone, perfluorobiphenyl, chloroheptafluoronaphthalene and bromoheptafluoronaphthalene. As oligomers, there may be mentioned homopolymer oligomers of such a fluoromonomer as tetrafluoroethylene, chlorotrifluoroethylene, dichlorodifluoroethylene, hexafluoropropylene or a perfluoro(alkyl vinyl ether), and copolymer oligomers of two or more of such monomers. Perfluoropolyethers comprising the structural unit —CF₂CF(CF₃)O— or —(CF₂)ₙ₁₀O— (n10 being an integer of 1 to 3) can also be used.

In the optical device of the present invention, the core may contain a rare earth metal ion and/or an inorganic fluorescent substance, a nonlinear optical material, or a photochromic material so that it may have optical functionality. By using as a core using a composition comprising the rare earth metal ion and/or inorganic fluorescent substance and a polymer material, it becomes possible to provide the core with such an optical function as optical amplification or light-emitting activity.

The cyclic ether copolymer of the present invention can be used as the above-mentioned core-forming polymer and, when used, it is preferred from the viewpoint of transparency, light-emitting efficiency and/or amplification efficiency, among others, that the cyclic ether copolymer be one in which at least one of R¹ and R² in the the above general formula (I) is F or a perfluoroalkyl group containing 1 to 5 carbon atoms and, in addition, in which the other hydrogen atoms in the molecular structure have been partly, more preferably wholly, substituted by fluorine atoms.

The polymer forming the core is herein referred to as “core-forming polymer”.

The composition comprising the rare earth metal ion and/or inorganic fluorescent substance, nonlinear optical material, or photochromic material and the above-mentioned core-forming polymer is herein sometimes referred to as “core-forming polymer composition”.

In the optical device of the present invention, the core may be formed by using an optical material comprising the above-mentioned cyclic ether copolymer and, further, the rare earth metal ion and/or inorganic fluorescent substance, nonlinear optical material, or photochromic material and preferably is one-formed by-using the optical material comprising the cyclic ether copolymer and, further, the rare earth metal ion.

In the optical device of the present invention, the inorganic fluorescent substance to be used in the core is a fluorescent substance capable of being excited by electromagnetic waves emitted from a light-emitting device and emitting a fluorescent light. The inorganic fluorescent substance is not particularly restricted but includes, among others, cerium-activated yttrium aluminum garnet type fluorescent substances, perylene derivatives, and copper-activated zinc selenide. When a nitride semiconductor is used as the light-emitting device, yttrium aluminum garnet type fluorescent substances are particularly preferred from the light resistance and/or efficiency viewpoint, among others.

The cerium-activated yttrium aluminum garnet type fluorescent substances have a garnet structure and, therefore, are highly resistant to heat, light and moisture, and have an excitation spectrum peak at around 450 nm. Their emission spectra have an emission peak at around 530 nm with a broad line wing to 700 nm. The term “cerium-activated yttrium aluminum garnet type fluorescent substances” as used herein should be most broadly construed and the yttrium (Y) in Y₃Al₅O₁₂:Ce can be substituted by at least one species selected from among Lu, Sc, La, Gd and Sm. Further, the aluminum (Al) can be substituted by at least one species selected from among Ga, In, B and Tl. By modifying the composition, it becomes possible to continuously adjust the light to be emitted. Thus, the intensity on the longer wavelength side can be continuously changed depending on the Gd content and, in this respect and in other respects, the above-mentioned substances satisfy the ideal conditions for converting the bluish light emission of nitride semiconductors to white light emission. In a similar way, Lu, Lc, Sc, Sm or the like may be added to attain the desired characteristics.

The inorganic fluorescent substances mentioned above can be obtained in the following manner. A raw material for Y, Gd, Ce, Sm, La, Al and Ga is prepared by mixing with oxides of them, or compounds these oxides readily convertible to oxides at elevated temperatures, as raw materials in a stoichiometric ratio. Alternatively, a mixed raw material is prepared by subjecting a solution of the rare earth element(s) Y, Gd, Ce, Sm and/or La in an acid in a stoichiometric ratio to coprecipitation with oxalic acid, calcining the coprecipitate and mixing the resulting coprecipitate oxide with aluminum oxide and gallium oxide. The raw material is supplemented with an appropriate amount of a fluoride such as ammonium fluoride as a flux, the mixture is placed in a crucible, calcination is carried out in air within a temperature range of 1350 to 1450° C. for 2 to 5 hours, and the calcination product is then ball milled in water, followed by washing, separation and drying and finally followed by sieving to give the desired substance.

As the rare earth metal ion to be used in the core-forming polymer composition, there may be mentioned at leat one species selected from the group consisting of erbium (Er), thulium (Tm), praseodymium (Pr), holmium (Ho), Neodymium (Nd), dysprosium (Dy), cerium (Ce), samarium (Sm) and europium (Eu) ions. The above-mentioned core-forming polymer contains the rare earth metal ion in the form of a cation, and the rare earth metal cation may comprise one single species or a mixture of a plurality of species.

The valence of each rare earth metal cation to be used in the core-forming polymer composition is not particularly restricted but the divalent or trivalent cation form is generally used, and the rare earth metal cations are generally incorporated in the form of rare earth metal compounds or complexes. Preferred as the rare earth metal compounds are halides such as chlorides, bromides and iodides; and such salts as nitrates, perchlorates, bromates, acetates, sulfates and phosphates in view of their good dispersibility in the core-forming polymer. Double nitrates, double sulfates, chelates, complexes and the like can also be used. For example, there may be mentioned sulfonamides, sulfonimides, β-diketones, sulfonic acids, phosphoric acids and so forth and, among them, fluorine-containing compounds derived therefrom are preferred.

In the optical device of the present invention, the rare earth metal ion-containing halides or salts to be judiciously used in the core are not particularly restricted but include, among others, praseodymium chloride, praseodymium bromide, praseodymium iodide, praseodymium nitrate, praseodymium perchlorate, praseodymium bromate, praseodymium acetate, praseodymium sulfate, praseodymium phosphate and like praseodymium salts, neodymium chloride, neodymium bromide, neodymium iodide, neodymium nitrate, neodymium perchlorate, neodymium bromate, neodymium acetate, neodymium sulfate, neodymium phosphate and like neodymium salts, europium chloride, europium bromide, europium iodide, europium nitrate, europium perchlorate, europium bromate, europium acetate, europium sulfate, europium phosphate and like europium salts, erbium chloride, erbium bromide, erbium iodide, erbium nitrate, erbium perchlorate, erbium bromate, erbium acetate, erbium sulfate, erbium phosphate and like erbium salts.

In the optical device of the present invention, the rare earth metal ion-containing complexes to be judiciously used in the core are not particularly restricted but include, among others, tris(dibenzoylmethido)erbium(III), tris(benzoyltrifluoroacetonato)erbium(III), tris(hexafluoroacetonato)erbium(III), tris(dibenzoylmethido)erbium(III), tris(benzoyltrifluoroacetonato)erbium(III), tris(hexafluoroacetonato)erbium(III), tris(dibenzoylmethido)neodymium(III), tris(benzoyltrifluoroacetonato)neodymium(III), tris(hexafluoroacetonato)neodymium(III) and so forth, and they may be tetrakis complexes, for example tetrakis(hexafluoroacetonato)neodymium(III). As other rare earth metal ion-containing complexes, there may be mentioned Nd[C₈F₁₇SO₂NSO₂C₈F₁₇]₃, Nd[C₄F₉SO₂NSO₂C₄F₉]₃, Nd[C₆F₅SO₂NSO₂C₆F₅]₃, Nd[C₄F₉SO₂NSO₂C₆F₅]₃, Nd[C₄F₉SO₂NSO₂C₈F₁₇]₃, Nd[C₆F₁₃SO₂NSO₂C₆F₁₃]₃, Nd[C₂F₅SO₂NSO₂C₂F₅]₃, Nd[CF₃SO₂NSO₂Cf₃]₃, Nd[C₄F₉SO₂NCOC₃F₇]₃, Nd[C₄F₉SO₂NCOCF₃]₃, Nd[O₃SC₈F₁₇]₃Nd[O₃SCF₃]₃, etc.

Preferred for use in optical amplifiers for optical communication among the above-mentioned rare earth metal compounds and complexes are those having fluorescent light-emitting ability in the near infrared region. More preferred are those neodymium salts, praseodymium salts, erbium salts, and complexes thereof which are capable of emitting fluorescent light at a wavelength of about 1300 to 1550 nm which is a signal wavelength suited for optical fibers made of an inorganic glass species such as silica glass. For optical amplification in the 650 nm zone which is in the visible wavelength region and employed in case of using an organic polymer material as optical fibers, europium salts and complexes are most suited. When the light-emitting devices are used as optical fibers, blue light-emitting thulium salts, green light-emitting terbium salts, and red light-emitting europium salts are preferred.

The rare earth metal ion may also be contained in a polymer complex represented by the general formula (V):
{Re[EEYRf⁴Rf⁵]₃}ₙ₁₁ (V).

In the above formula, Re represents a rare earth metal, Rf⁴ and Rf⁵ are the same or different and each represents a perhalogenated organic group, E represents an element of the group VIA of the periodic table, and Y represents an element of the group VA of the periodic table.

From the highly efficient optical amplification and light emission viewpoint, —OC₆F₅ and —CₘF₂ₘ₊₁ (m=1 to 8) may be mentioned as preferred species of Rf⁴ and Rf⁵.

From the highly efficient optical amplification and light emission viewpoint, O and S may be mentioned as preferred species of E, and O may be mentioned as a more preferred species.

From the highly efficient optical amplification and light emission viewpoint, N and P may be mentioned as preferred species of Y, and P may be mentioned as a more preferred species.

The core-forming polymer composition preferably contains a rare earth metal ion and/or an inorganic fluorescent substance in an amount of 0.001 to 25% by mass (as for the rare earth metal ion content, % by mass as an ion; hereinafter the same shall apply). Although the situation may vary depending on the rare earth metal ion and/or inorganic fluorescent substance species used and on the core-forming polymer species, the desired properties such as the intended optical amplification activity may not be acquired at rare earth metal ion and/or inorganic fluorescent substance addition levels below 0.001% by mass and, at levels exceeding 25% by mass, the dispersibility of the rare earth metal ion and/or inorganic fluorescent substance may become poor; either of the cases is unfavorable. In utilizing as parts for optical communications such as optical amplifiers or optical waveguides or as light emitters, a more preferred lower limit to the content of the rare earth metal ion and/or inorganic fluorescent substance from the fluorescent intensity viewpoint is 0.01% by mass, a still more preferred lower limit is 0.1% by mass, a particularly preferred lower limit is 0.5% by mass, and a more preferred upper limit is 20% by mass, a still more preferred upper limit is 15% by mass and a particularly preferred upper limit is 10% by mass. The content of the rare earth metal ion and/or inorganic fluorescent material can be quantitatively determined by burning the organic components in an electric oven at a temperature of about 600° C. and quantitating the ash component(s) or by such a physicochemical technique as fluorescent X ray analysis.

In the case of optical amplifiers such as optical fiber amplifiers serving to recover the communication light from attenuation, an excitation light (pump light) is always continuously passed therethrough to effectively excite the rare earth metal ion and/or inorganic fluorescent substance emitting a fluorescent light having a communication light wavelength so as to generate a fluorescent light having the same pulse waveform as that of the communication light by the communication light pulse-due phenomenon of induced emission; the amplifying effect is thus produced. Therefore, when the core-forming polymer composition mentioned above is used in the field of optical amplifiers, it is required to have a fluorescent light-emitting ability in the rare earth metal ion- and/or inorganic fluorescent substance-due excitation light.

Further, in the case of light-emitting devices, they contain a rare earth metal ion emitting a fluorescent light in the visible to near infrared region, and they are irradiated with an excitation light to obtain a light emission at the desired wavelength. Therefore, when the core-forming polymer mentioned above is used in the field of light emitters, it is required to have a fluorescent light-emitting ability in the rare earth metal ion- and/or inorganic fluorescent substance-due excitation light.

The core-forming polymer composition can be prepared by incorporating a rare earth metal ion and/or inorganic fluorescent substance into the core-forming polymer. The method of incorporating the rare earth metal ion and/or inorganic fluorescent substance into the core-forming polymer is not particularly restricted but may comprise dissolving or dispersing the above-mentioned rare earth metal ion- and/or inorganic fluorescent substance-containing compound or complex in the core-forming polymer, or causing the rare earth metal ion and/or inorganic fluorescent substance to be carried on the core-forming polymer via ionic bonding, coordination bonding, or clathration, for instance.

As the method of preparing the core-forming polymer composition comprising the rare earth metal ion and/or inorganic fluorescent substance and the core-forming polymer, there may more specifically be mentioned, among others, (1) the method comprising adding the rare earth metal ion- and/or inorganic fluorescent substance-containing compound or complex to the monomers giving the structural units of the core-forming polymer and then forming the core-forming polymer by such a known method of synthesis as solution polymerization or anionic polymerization, (2) the method comprising adding the rare earth metal ion- and/or inorganic fluorescent substance-containing compound or complex to a solution prepared by dissolving the core-forming polymer in a solvent and, after mixing up, removing the solvent, and (3) the method comprising melt-kneading the core-forming polymer with the rare earth metal ion- and/or inorganic fluorescent substance-containing compound or complex. Among them, the method (2) is most judiciously used since the dispersibility of the rare earth metal ion- and/or inorganic fluorescent substance-containing compound or complex in the core-forming polymer is good. The particularly judicious method comprises dissolving the core-forming polymer in a solution of the rare earth metal ion- and/or inorganic fluorescent substance-containing compound or complex and raising the temperature of the uniform solution obtained to distill off the solvent. The composition obtained in the form of a solution or dispersion may also be used as a raw material of the solution in the process of optical devices formation without distilling off the solvent.

By using a composition comprising a nonlinear optical material and a polymer material for cores, it becomes possible to provide the core with such an optical functionality as wavelength conversion.

The cyclic ether copolymer of the present invention can be used as the above-mentioned polymer for cores. When such cyclic ether copolymer is used, it is preferred from the viewpoint of transparency, light-emitting efficiency and/or amplification efficiency, among others, that it be one in which at least one of R¹ and R² in the general formula (I) given above is F or a perfluoroalkyl group containing 1 to 5 carbon atoms and, in addition, which is one resulting from substitution of a fluorine atom for at least part of the other hydrogen atoms in the molecular structure, more preferably for all the other hydrogen atoms in the molecular structure.

The nonlinear optical material is a material substance which, when used in functional optical devise or optical parts, produces nonlinear optical effects. The term “nonlinear optical effects” indicates those optical effects manifested as a result of the nonlinear polarization becoming no more negligible in the polarization of atoms or molecules as induced by an external strong electric field. For example, Pockels effect, parametric oscillation, secondary harmonic generation (SHG) and so forth are known as secondary nonlinear optical effects. Known as tertiary nonlinear optical effects are, for example, Kerr effect, statically induced SHG, third harmonic generation (THG), and light intensity-dependent changes in refractive index.

The secondary nonlinear optical effects can be utilized in wavelength conversion (SHG) devices, electrooptic modulators and so forth, and the tertiary nonlinear optical effects can be utilized in wavelength conversion (THG) devices, high-speed optical shutters, optical operations, optical bistable devices, optical switching, etc.

The nonlinear optical material to be used in the core of the optical device of the present invention is not particularly restricted but includes, among others, such organic compounds as 2-methyl-4-nitroaniline [MNA], 1-(4-nitrophenyl)-3,5-dimethylpyrazole (DMNP), 2-(2,2-dicyanovinyl)anisole (DIVA), 4′-nitrobenzylidene-3-acetamino-4-methoxyaniline (MNBA), 4-[N-(2-hydroxyethyl)-N-ethylamino]-4′-nitroazobenzene (DR-1), 4-nitroaniline, 2-nitroaniline, 3-nitroaniline, 2-methyl-4-nitroaniline, 2-methyl-4-nitro-N-methylaniline, 4-nitro-N-cyanomethylaniline, N,N-dimethyl-4-nitroaniline, 2-amino-5-nitropyridine, 2-(N-cyclooctyl)amino-5-nitropyridine, 4-[1-(2-methylol)pyrrolidinyl]-nitrobenzene, 2-[1-(2-methylol)pyrrolidinyl]-3-nitropyridine, 2-[N-(α-methylbenzyl)amino]-5-nitropyridine, methyl N-(2,4-dinitrophenyl)alaninate, 1-(4-nitrophenyl)-3,5-phenylpyrrole, 2,4-dinitroaniline, 2-fluoronitrobenzene, 4-fluoronitroaniline, 2-chloro-4-nitroaniline, 2-bromo-4-nitroaniline, 4-nitro-2-(N-acetyl)amino-N,N-dimethylaniline, 3-methyl-4-nitropyridine N-oxide, 4-nitroanisole, 4-nitrotoluene, 4-cyanoaniline, 4-cyano-N,N-dimethylaniline, 4-cyanoanisole, 4-cyanotoluene, 4-aminoacetophenone, 4-N,N-dimethylaminopyridine N-oxide, 4-N,N-dimethylamino-P-nitrostyrene, 4-N,N-dimethylaminocinnamaldehyde, 4-methoxycinnamaldehyde, 1-(4-N,N-dimethylaminophenyl)-4-nitrobuta-1,3-diene, 1-(4-cyanophenyl)-4-(4-N,N-dimethylaminophenyl)-buta-1,3-diene, 4-nitro-trans-stilbene, 4-chloro-trans-stilbene, trans-4-azastilbene, 4-amino-trans-stilbene, 4-N,N-dimethylamino-trans-stilbene, 4-amino-4′-nitro-trans-stilbene, 4-N,N-dimethylamino-4′-nitro-trans-stilbene, 3-methyl-4-methoxy-4′-nitro-trans-stilbene, 4-methyl-4′-nitro-trans-stilbene, 4-chloro-4′-nitro-trans-stilbene, 4-methoxy-4′-cyano-trans-stilbene, 4-N,N-dimethylamino-4′-chloro-trans-stilbene, 4-N,N-dimethylamino-4′-azastilbene N-oxide, 2-(4-cyanomethylenecyclohexa-2,5-dienylidene)imidazolidine, 2-(4-dicyanomethylenecyclohexa-2,5-dienylidene)imidazolidine, 4-[(1-methyl-4-(1H)-pyridinylidene)ethylidene]-2,5-cyclohexadien-1-one,3-ethyl-2-[2-(4-oxo-2,5-cyclohexadienylidene)ethylidene]-2,3-dihydrobenzothiazole, 2-[6-(4-carboxyphenylamino)cyclohexa-2,4-dienylidene]-3-ethyl-2,3-dihydroxybenzothiazole, monomethylurea, sym-dimethylurea, tetramethylurea, N,N′-di(4-ethylcarboxyl)phenylmethylenediamine, tetramethyltetrathiafulvalene-cyanoethoxycarbonylmethylene complex (charge transfer complex), N-methylmerocyanine, and N-octadecylmerocyanine, etc. The above-enumerated organic compounds can be used singly or two or more of them may be used in combination.

The content of the nonlinear optical material is preferably 0.1 to 50 parts by mass relative to 100 parts by mass of the core-forming polymer. When the usage of the nonlinear optical material is less than 0.1 part by mass, the electrooptical effects tend to become poor and, when it is above 50 parts by mass, thin film formation may become impossible and other problems such as opacification tend to arise. A more preferred lower limit is 0.5 part by mass, and a more preferred upper limit is 30 parts by mass.

The optical device of the present invention may be one having electrodes properly provided on top and bottom of a nonlinear optical layer according to need. As the electrodes, there may be mentioned various electric conductors, and ITO, gold, silver, chromium, aluminum and the like are preferably used as the materials. The nonlinear optical waveguide device of the present invention can be used as a device for use in various fields, for example as a linear type device, Y branch type device, directional coupler type device, Mach-Zehnder interferometer type device, Fabry-Perot resonator type device or periodically poled type SHG device.

Such a polymer composition generally shows no orientation and, as such, cannot be used as a material of optical switches, modulating devices and the like which utilize some or other electrooptical effects. Generally, the technique of producing electrooptical effects by applying a direct current electric field with heating, namely by poling, is applied to polymer materials showing no orientation.

The method of preparing a core-forming polymer composition composed of a nonlinear optical material and a core-forming polymer is not particularly restricted. Thus, the nonlinear optical material may be dissolved or dispersed in the core-forming polymer or caused to be carried by the core-forming polymer-constituting polymer in the main chain, at main chain termini or on side chains thereof via ionic bonding, coordination bonding, clathration, etc.

As specific methods of preparing the core-forming polymer composition comprising the nonlinear optical material and core-forming polymer, there may be mentioned, among others, (1) the method comprising adding the nonlinear optical material to the monomers to constitute the core-forming polymer and then forming the polymer for the core material by such a known method of synthesis as solution polymerization or anionic polymerization, (2) the method comprising dissolving the core-forming polymer in a solvent, admixing the nonlinear optical material with the solution prepared, and removing the solvent, and (3) the method comprising subjecting the core-forming polymer and nonlinear optical material to melt-kneading. Among these methods, the method (2), which makes it possible to uniformly disperse the nonlinear optical material in the core-forming polymer, is most preferred. Thus, according to a particularly preferred method, the core-forming polymer is dissolved in a solution of the nonlinear optical material and removing the solvent by raising the temperature of the uniform solution obtained. It is also possible to use the composition in a solution or dispersion form as the raw material of the solution in the process of waveguide formation, which is to be described later herein, without distilling off the solvent.

By using a composition comprising a photochromic material and a polymer material for cores, it is possible to provide the core with such an optical functionality as switching, filtering, etc. The cyclic ether copolymer of the present invention can be used as the core-forming polymer. When such cyclic ether copolymer is used, it is preferred from the viewpoint of transparency, light-emitting efficiency and/or amplification efficiency, among others, that it be one in which at least one of R¹ and R² in the general formula (I) given above is F or a perfluoroalkyl group containing 1 to 5 carbon atoms and, in addition, which is one resulting from substitution of a fluorine atom for at least part of the other hydrogen atoms in the molecular structure, more preferably for all the other hydrogen atoms in the molecular structure.

The photochromic material is not particularly restricted provided that it can be dispersed in a matrix. Suited for use are, however, benzospiran compounds, spiroxazine compounds, dithizone mercury compounds, phenazine compounds, phenothiazine compounds and the like.

The method of producing an optical device according to the present invention produces an optical device by using the above-mentioned cyclic ether copolymer. The method of producing an optical device comprises the step (1) of producing the cyclic ether copolymer, the step (2) of preparing a resin composition for coating by using the cyclic ether copolymer and a solvent for dissolving the cyclic ether copolymer, the step (3) of forming a lower clad on a substrate by using the resin composition for coating, the step (4) of forming a core on the lower clad, and the step (5) of forming an upper clad, by using the resin composition for coating, on the core obtained by the above step (4) and formed on the lower clad.

Radical polymerization is generally used as the method of producing the cyclic ether copolymer in the above step (1), and any radical polymerization technique, namely solution polymerization, suspension polymerization, bulk polymerization or emulsion polymerization, may be employed. Among them, solution polymerization and suspension polymerization are preferred because of the ease of adjusting the composition and molecular weight of the resulting cyclic ether copolymer.

Utilizable as the radical generation source are a radical polymerization initiator, light and heat, among others. The production in the presence of a radical polymerization initiation is preferred since the degree of polymerization can be controlled, the reaction can be allowed to proceed smoothly and the polymer can be obtained in high yields.

Utilizable as the radical polymerization initiator are peroxides and azo initiators, among others.

As the peroxides, there may be mentioned, for example, peroxydicarbonates such as n-propyl peroxydicarbonate, i-propyl peroxydicarbonate, n-butyl peroxydicarbonate, t-butyl peroxydicarbonate and bis(4-tert-butylcyclohexyl) peroxydicarbonate [TCP]; oxyperesters such as α,α′-bis(neodecanoylperoxy) diisopropylbenzene, cumyl peroxyneodacanoate, 1,1,3,3-tetramethylbutyl peroxyneodecanoate, 1-cyclohexyl-1-methylethyl peroxyneodecanoate, t-hexyl peroxyneodecanoate, t-butyl peroxyneodecanoate, t-hexyl peroxypivalate, t-butyl peroxypivalate, 1,1,3,3-tetramethylbutyl peroxy-2-ethylhexanoate, 2,5-dimethyl-2,5-bis(2-ethylhexanoylperoxy)hexane, t-hexyl peroxy-2-ethylhexanoate, t-butyl peroxy-2-ethylhexanoate, t-butyl peroxyisobutyrate, t-hexylperoxy isopropyl monocarbonate, tert-butyl peroxymaleic acid, t-butyl peroxy-3,5,5-trimethylhexanoate, t-butyl peroxylaurate, 2,5-dimethyl-2,5-bis(m-toluoylperoxy)hexane, t-butylperoxy isopropyl monocarbonate, t-butylperoxy 2-ethylhexyl monocarbonate, t-hexyl peroxybenzoate, 2,5-dimethyl-2,5-bis(benzoyl)hexane, t-butyl peroxyacetate, t-butyl peroxy-m-toluate/peroxybenzoate mixture, t-butyl peroxybenzoate and di-t-butyl peroxyisophthalate; diacyl peroxides such as isobutyryl peroxide, 3,5,5-trimethylhexanoyl peroxide, octanoyl peroxide, lauroyl peroxide, stearoyl peroxide, succinic acid peroxide, m-toluoyl peroxide and benzoyl peroxide; peroxyketals such as 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-bis(t-butylperoxy)-2-methylcyclohexane, 1,1-bis(t-butylperoxy)cyclohexane, 2,2-bis(t-butylperoxy)butane, n-butyl 4,4-bis(t-butylperoxy)valerate and 2,2-bis(4,4-di-tert-butylperoxycyclohexyl)propane; dialkyl peroxides such as ′,′α-bis(t-butylperoxy) diisopropylbenzene, dicumyl peroxide, 2,5-dimethyl-2,5-bis(t-butylperoxy)hexane, t-butyl cumyl peroxide, di-t-butyl peroxide and 2,5-dimethyl-2,5-bis(t-butylperoxy)-3-hexyne; hydroperoxides such as p-menthane hydroperoxide, diisopropylbenzene hydroperoxide, 1,1,3,3-tetramethylbutyl hydroperoxide, cumene hydroperoxide and t-butyl hydroperoxide; persulfuric acid salts such as ammonium persulfate, potassium persulfate and sodium persulfate; and, further, perchloric acid salts, hydrogen peroxide, and so forth.

Fluorinated peroxides are also utilizable, and one or two or more species selected from among fluorine-containing diacyl peroxides, fluorine-containing peroxydicarbonates, fluorine-containing peroxydiesters and fluorine-containing dialkyl peroxides are preferred. Preferred among them are pentafluoropropionoyl peroxide (CF₃CF₂COO)₂, heptafluorobutyryl peroxide (CF₃CF₂CF₂COO)₂, 7H-dodecafluoroheptanoyl peroxide (CHF₂CF₂CF₂CF₂CF₂CF₂COO)₂ and like difluoroacyl peroxides are preferred from the viewpoint of the affinity for monomers in the step of polymerization reaction and of the improvement in transparency in the near infrared wavelength region of the product polymer.

As the azo radical polymerization initiators, there may be mentioned, among others, 2,2′-azobisisobutyronitrile, 2,2′-azobis(2,4-dimethylvaleronitirile), 2,2′-azobis(2-methylvaleronitrile), 2,2′-azobis(2-cyclopropylptopionitrile), dimethyl 2,2′-azobisisobutyrate, 2,2′-azobis[2-(hydroxymethyl)propionitrile] and 4,4′-azobis(4-cyanopentenoic acid).

The production of the cyclic ether copolymer is preferably carried out by using a fluorine-free organic peroxide since heat stability and adhesion to substrates can be improved and, among the above-mentioned fluorine-free organic peroxides, an organic peroxide comprising at least one species selected from the group consisting of oxyperesters, diacyl peroxides and peroxydicarbonates is more preferred.

Preferably used as the polymerization initiator is a polymerization initiator containing a carbonyl group within the molecule since it can further provide the polymer chain terminus with an adhesive terminus, so that the adhesion to substrates can be improved.

Further, it is judicious to modify the terminus by post-polymerization heating and/or hydrolysis treatment, for instance, to thereby introduce an adhesive functional group and to improve adhesion to substrates.

The addition level of the polymerization initiator is preferably within the range of 0.1 to 5 mole percent per mole of the monomer composition for the production of the cyclic ether copolymer. When the addition level of the polymerization initiator is lower than 0.1 mole percent, the molecular weight will increase, the terminal adhesive functional group content will decrease, and the adhesion to substrates may possibly decrease and, at levels higher than 5 mole percent, the molecular weight will markedly decrease and film formation may become impossible. A more preferred upper limit is 3 mole percent.

As the solvent to be used in the above-mentioned polymerization, there may be mentioned fluorinated solvents such as perfluorobenzene, perfluoro(2-butyltetrahydrofuran), perfluorotrialkylamines represented by the following general formula:
N(CₙF₂₊₁)₃
(in which n represents an integer of 2 to 4), HCFC-225, CFC-113, HCFC-141B, perfluoroalkanes represented by the following general formula:
CₙF₂ₙ₊₂
(in which n represents an integer of 6 to 8), and fluorine- and chlorine-containing perhaloalkanes represented by the following general formula
F(CFClCF₂)ₙCl
(in which n represents an integer of 1 to 7); and fluorine-containing ether type solvents such as CHF₂CF₂OCHF₂, (CF₃)₂CFOCH₃, CF₃CF₂CF₂OCH₃, CHF₂CF₂OCH₃, CF₃CF₂CH₂OCHF₂, CF₃CFHFCF₂OCH₃, CHF₂CF₂OCH₂CF₃, C₄F₉OCH₃, CF₃CF₂CH₂OCF₂CHF₂, (CF₃)₂CHCF₂OCH₃, CF₃CFHCF₂OCH₂CF₃, C₄F₉OCH₂CH₃, CF₃CHFCF₂OCH₂CF₂CF₃, CF₃CHFCF₂CH₂OCHF₂, CHF₂CF₂CH₂OCF₂CHF₂, CF₃CFHCF₂OCH₂CF₂CF₂H and CHF₂CF₂CF₂CF₂CH₂OCH₃. Judiciously used among them are HCFC-225, CFC-113, HCFC-141B and perfluorohexane. Two or more of the fluorinated solvents may also be used in combination. Where appropriate, a sulfoxide solvent such as dimethyl sulfoxide; an amide solvent such as dimethylformamide; an ether solvent such as dioxane, and/or a like hydrocarbon type solvent may by added.

In the above-mentioned polymerization, the concentration of the 1,3-dioxole ring structure-containing compound is preferably within the range of 2 to 50% by mass.

As for the polymerization temperature, the polymerization is preferably carried out at a temperature at which the polymerization initiator decomposes, and the temperature is generally selected within the range of 0 to 100° C. depending on the decomposition temperature of the polymerization initiator. For example, the polymerization can be carried out within the range of 35° C. to 80° C.

The time required for the polymerization is generally selected within the range of 1 to 36 hours depending on the decomposition half-life of the polymerization initiator. The ordinary range is 3 to 24 hours in most cases, however.

As the additive to be used in the above polymerization, there may be mentioned ethane, methanol, THF, toluene, xylene, ethylbenzene, cumene, methylene chloride, chloroform, carbon tetrachloride, carbon tetrabromide, ethylene dichloride, or hydrocarbon mercaptans such as n-butylmercaptan and n-octylmercaptan, and like molecular weight modifiers, among others.

As the method of applying the resin composition for coating onto the substrate in the step (3), there may be mentioned the spin coating, dip coating, gravure coating, roll coating, spray coating, and bar coater coating methods, for instance. In view of the ease of thin film formation, the spin coating and dip coating methods are preferred.

In the step (3), the resin composition for coating is applied and then subjected to drying. The drying temperature is preferably lies in the range from room temperature, which is generally about 20° C., up to a temperature lower than the glass transition point of the polymer. A preferred upper limit to the drying temperature is 90° C., a more preferred lower limit is 30° C., and a still more preferred upper limit is 70° C. The drying may be carried out under reduced pressure.

In the step (3), after drying of the resin composition, if necessary, baking may be conducted at a temperature not lower than the glass transition point for improving leveling.

If the step (4) is carried out immediately after completion of the step (3) and when the clad and core are soluble only in a common solvent, there arises the possibility of intermixing, namely intermingling of the clad applied in advance with the core applied in the step (4). In the practice of the present invention, it is of course possible to further provide an intermixing preventing thin film layer by using a material having no solvent common to the core and clad. The material for forming this preventing layer may be either an inorganic material or an organic material. Utilizable as the inorganic material are SiO₂, MgF₂, CaF₂ and the like. Utilizable as the organic material are polyimides and silicone polymers, among others. As for the method of forming, various vacuum vapor evaporation coating methods comprising resistance heating, electron beam heating, or sputtering, for instance, and, further, the spin on glass method and the spin coat method can be utilized.

In the step (4), the core is as described hereinabove.

In the step (4), the core can be formed by any of the conventional methods.

In the step (4), an optical path is formed by patterning of the core. As the method of patterning, there may be mentioned the method using a photoresist, as disclosed in Japanese Kokai Publication Hei-04-190202, the direct light exposure method, the photobleaching method, the electron-beam lithography method, and the transfer method, among others.

The optical path can be made so as to be rectangular in cross section, with a path width of 8 to 10 μm.

The optical path refers to the core region through which light travels whereas the optical waveguide includes, within the meaning thereof, not only the core but also the clad. Thus, both the terms should be distinguished from each other.

The sum of the thickness of the upper clad formed in the step (5) and the thickness of the lower clad formed in the step (3) is preferably 10 to 1000 μm. A more preferred lower limit is 20 μm, and a more preferred upper limit is 500 μm.

The method of producing an optical device comprising an optical waveguide formed by using the optical material comprising the above-mentioned cyclic ether copolymer is not restricted to the method described above but mention may further be made, for example, of the method comprising omitting the step (3) and forming the core directly on the substrate, followed by clad formation, and the method comprising omitting the step (4) and forming ridge type optical waveguides without covering clad.

As other useful core patterning methods, there may be mentioned relief printing, lithography (offset printing), intaglio printing (gravure printing), stencil printing (screen printing), and electrophotographic printing, among others.

The cyclic ether copolymer of the present invention, and the laminate and resin composition for coating as formed by using that copolymer have not only the optical characteristics described hereinabove but also the characteristics of fluororesins in general, namely low permittivity, low surface free energy, chemical stability, heat resistance, electrical insulating quality and so forth and, therefore, can be used also in other fields of application than the optical field.

As such fields of use, there may specifically be mentioned electric wire coverings, magnetic recording medium protecting layers, safety glass laminating materials, optical device adhesives, solar cell light receiving face materials, color filter protecting layers, flux creep-up preventing agents, mold release agents, semiconductor protecting layers, airplane windowpane materials, mirror surface covering materials, mirror base materials, fishing lines, semiconductor-carriers, pellicle protecting film materials, electrophotographic photosensor surface layers, nonlinear optical devices, photochromic molding base materials, filters, supporting members for use in electrophoresis, photoreactors, bioreactors, ultraviolet lamps, etc. Further, they can form pinhole-free very thin films and therefore can be used as moistureproof coating materials for electronic parts, materials for manufacturing insulating films, weather-resistant film materials, materials for manufacturing separation membranes such as oxygen-enriching membranes, coating materials, etc. Further, they have water- and oil-repellent properties and therefore can be also used as water- and oil-repellent treatment of fibers, carpets, paper and so on.

### BEST MODES FOR CARRYING OUT THE PRESENT INVENTION

The following examples illustrate the present invention in further detail. It is to be noted, however, that these examples are by no means limitative of the scope of the present invention.

### EXAMPLE 1

A 300-mL SUS316 autoclave was charged with 300 g of CFC-113 and 0.146 g (corresponding to 0.167 mole percent relative to the total number of moles of charged monomers) of 4,4′-bis(t-butylcyclohexyl)peroxydicarbonate, the contents were cooled to 0° C., and the reaction system inside was purged three times with nitrogen. Then, 30 g of perfluoro-2,2-dimethyl-1,3-dioxole was fed to the autoclave and 9.6 g of tetrafluoroethylene was then fed thereto, and the resulting mixture was stirred at 40° C. for 10 hours.

After the reaction, the polymer produced was recovered by adding hexane to the reaction mixture, and dried to give 35 g of a cyclic ether copolymer.

### EXAMPLE 2

A 300-mL SUS316 autoclave was charged with 300 g of CFC-113, 0.1 g of tetrahydrofuran, and 0.142 g (corresponding to 0.149 mole percent relative to the total number of moles of charged monomers) of 4,4′-bis(t-butylcyclohexyl)peroxydicarbonate, the contents were cooled to 0° C., and the reaction system inside was purged three times with nitrogen. Then, 30 g of perfluoro-2,2-dimethyl-1,3-dioxole was fed to the autoclave and 11.6 g of tetrafluoroethylene was then fed thereto, and the resulting mixture was stirred at 40° C. for 10 hours.

After the reaction, the polymer produced was recovered by adding hexane to the reaction mixture, and dried to give 26 g of a cyclic ether copolymer.

### EXAMPLE 3

A 300-mL SUS316 autoclave was charged with 300 g of HCFC-225 and 1.47 g (corresponding to 1.53 mole percent relative to the total number of moles of charged monomers) of 4,4′-bis(t-butylcyclohexyl)peroxydicarbonate, the contents were cooled to 0° C., and the reaction system inside was purged three times with nitrogen. Then, 30 g of perfluoro-2,2-dimethyl-1,3-dioxole was fed to the autoclave and 11.7 g of tetrafluoroethylene was then fed thereto, and the resulting mixture was stirred at 40° C. for 10 hours.

After the reaction, the polymer produced was recovered by adding hexane to the reaction mixture, and dried to give 32 g of a cyclic ether copolymer.

### COMPARATIVE EXAMPLE 1

A 300-mL SUS316 autoclave was charged with 300 g of CFC-113 and 0.012 g (corresponding to 0.013 mole percent relative to the total number of moles of charged monomers) of 4,4′-bis(t-butylcyclohexyl)peroxydicarbonate, the contents were cooled to 0° C., and the reaction system inside was purged three times with nitrogen. Then, 30 g of perfluoro-2,2-dimethyl-1,3-dioxole was fed to the autoclave and 11.0 g of tetrafluoroethylene-was then fed thereto, and the resulting mixture was stirred at 30° C. for 24 hours.

After the reaction, the polymer produced was recovered by adding hexane to the reaction mixture, and dried to give 39 g of a cyclic ether copolymer.

### COMPARATIVE EXAMPLE 2

A 300-mL SUS316 autoclave was charged with 300 g of CFC-113 and 1.20 g (corresponding to 1.48 mole percent relative to the total number of moles of charged monomers) of 4,4′-bis(t-butylcyclohexyl)peroxydicarbonate, the contents were cooled to 0° C., and the reaction system inside was purged three times with nitrogen. Then, 33 g of perfluoro-2,2-dimethyl-1,3-dioxole was fed to the autoclave and 6.77 g of tetrafluoroethylene was then fed thereto, and the resulting mixture was stirred at 40° C. for 8 hours.

After the reaction, the polymer produced was recovered by adding hexane to the reaction mixture, and dried to give 30 g of a cyclic ether copolymer.

The cyclic ether copolymers obtained were evaluated as follows:

[Intrinsic Viscosity η]

At least four sufficiently dilute solutions differing in concentration were prepared by dissolution in perfluoro-2-butyltetrahydrofuran at 35° C. and subjected to viscosity measurements using an Ubbellohde capillary viscometer, and the reduced viscosity values as obtained were extrapolated to the concentration of zero to give the intrinsic viscosity.

[Glass Transition Point Tg]

The value of the midpoint on the endotherm obtained by using the technique of differential scanning calorimetry [DSC] at a rate of heating of 10° C./minute was taken as the glass transition point.

[1,3-Dioxole Ring Structure Unit Content]

The content was determined by F-19 nuclear magnetic resonance [¹⁹F-NMR] spectrometry.

[Apparent Melt Viscosity (AMV)]

The polymers of Examples 1 to 3 were each measured for apparent melt viscosity [AMV]. The AMV was calculated from the melt flow rate [MFR] determined by the method of ASTM D 2116 at 230° C. under a load of 383.1 g, as follows:
AMV (pascal·sec)=6.4×load (g)/MFR (g/10 min).
[Solubility Testing]

The cyclic ether copolymers obtained in Examples 2 and 3 and Comparative Example 2 were each measured for solubility in HCFC-225.

(Coated Film Surface Conditions and Cross Cut-Test]

Each of the cyclic ether copolymers obtained in Examples 1 to 3 and Comparative Examples 1 and 2 was dissolved in perfluoro-2-butyltetrahydrofuran to a concentration of 10% by mass, and the solution obtained was filtered through a 0.5-μm filter and applied onto a silicon wafer by spin coating at a rotation speed of 500 rpm for 10 seconds and then at a rotation speed of 1000 rpm for 30 seconds. After 6 hours of drying in air, the coated wafer was dried at 100° C. for 2 hours to give a laminate. The condition of the coated film surface of the laminate obtained was observed and evaluated according to the following criteria:
⊚: Very excellent in smoothness;
◯: Almost smooth;
Δ: Slight orange peel surface/surface waviness observed;
X: Intense orange peel surface/surface waviness observed.

Then, a cross cut test was carried out according to JIS K 5400 6.15.

The results obtained in the above manner are shown in Table 1.

| | | | | | Comparative | Comparative |
|---|---|---|---|---|---|---|
| | | Example 1 | Example 2 | Example 3 | Example 1 | Example 2 |
| Physical | 1,3-Dioxole ring | 53 | 54 | 51 | 51 | 60 |
| properties | structural unit | | | | | |
| of cyclic | (mole %) | | | | | |
| ether | Intrinsic viscosity | 0.39 | 0.24 | 0.20 | 1.76 | 0.22 |
| copolymer | [η] | | | | | |
| | (dl/g) | | | | | |
| | Glass trasition | 120 | 120 | 110 | 122 | 160 |
| | point [Tg] (° C.) | | | | | |
| | Apparent melt | 198 | ≦100 | ≦100 | — | — |
| | viscosity | | | | | |
| | [AMV] (Pa · s) | | | | | |
| | Refractive index | 1.322 | 1.320 | 1.324 | 1.323 | 1.316 |

| | | | | | |
|---|---|---|---|---|---|
| Solubility test | — | Soluble | Soluble | — | Insoluble |
| (HCFC225) | | | | | |
| Coated surface condition | ◯ | ⊚ | ⊚ | Δ | X |
| Cross cut test | 100/100 | 100/100 | 100/100 | 0/100 | 20/100 |

Table 1 indicates that the copolymer of Example 1, in spite of its being almost equivalent in glass transition point to the copolymer of Comparative Example 1, has a greatly different intrinsic viscosity and is very resistant to peeling in the cross cut test. It is also seen that the copolymer of Example 2, in spite of its being almost equivalent in intrinsic viscosity to the copolymer of Comparative Example 2, has a greatly different glass transition point and is superior in solubility in HCFC-225.

### EXAMPLE 4

### Light Waveguide Construction

About 100-μm-thick samples were subjected to refractive index measurements at 25° C. with light at the wavelength of 589 nm using Abbe's refractometer. The results are shown in Table 1.

As a result, it was found that a core/clad type waveguide can be formed by using the polymer of Example 2 (refractive index: 1.320) as the clad and the polymer of Example 3 (refractive index: 1.324) as the core.

The cyclic ether copolymer obtained in Example 2 was dissolved in perfluoro-2-butyltetrahydrofuran at a concentration of 5% by mass to give a solution. The solution obtained was filtered through a 0.5-μm filter and applied onto a silicon wafer by spin coating at a rotation speed of 200 rpm for 10 seconds and then at a rotation speed of 500 rpm for 30 seconds. After 6 hours of drying in air, the coated wafer was dried at 100° C. for 2 hours. Thus, a clad layer with a thickness of about 15 μm was obtained on the silicon substrate. Then, the polymer of Example 3 was dissolved in perfluoro-2-butyltetrahydrofuran at a concentration of 10% by mass to give a solution. The solution obtained was filtered through a 0.5-μm filter and applied onto the previously obtained clad layer by spin coating at a rotation speed of 500 rpm for 10 seconds and then at a rotation speed of 1000 rpm for 30 seconds. After 6 hours of drying in air, the coat was dried at 100° C. for 2 hours. Thus, the clad component polymer was coated with the core component polymer to a thickness of about 8 μm.

Then, resist application, prebaking, light exposure, development and afterbaking were carried out to give a patterned resist layer. The core portion not protected by the resist layer was removed by dry etching. The remaining resist was removed by wet etching, and the core component polymer was processed to a straight rectangular pattern with a length of 50 mm, a width of 8 μm and a height of 8 μm.

Thereon was formed a clad portion (upper clad portion) in the same manner as in the formation of the lower clad portion to give an optical waveguide.

The transmission losses of this optical waveguide were measured by the cutback method and found to be not greater than 0.10 dB/cm at the wavelength 633 nm, 0.11 dB/cm at the wavelength 1310 nm, and 0.22 dB/cm at the wavelength 1550 nm. Thus, light in the communication wavelength region, from visible to near infrared, could be transmitted satisfactorily.

After 168 hours of storage under the conditions of 85° C. and 85% humidity, there were little changes in loss values.

### EXAMPLE 5

### Light Amplifying Device Construction

The cyclic ether copolymer obtained in Example 3 was dissolved in HCFC-225 and the polymer concentration was adjusted to 8% by mass. Separately, europium-acetylacetone complex was dissolved in methyl ethyl ketone [MEK] and the europium ion content was adjusted to 10% by mass. Both solutions were mixed up and the europium-acetylacetone complex concentration was adjusted to 1% by mass relative to the polymer to give a solution. An optical waveguide containing the rare metal ion in the core was constructed in the same manner as in Example 4 except that the above solution was used as the core-forming material.

Then, light with a wavelength of 633 nm was passed through the thus-obtained optical waveguide and the transmission loss was measured and found to be 0.4 dB/cm.

Further, the thus-formed waveguide was irradiated with light using an ultraviolet lamp and observed from above the waveguide main face, upon which a red light emission pattern intrinsic in the Eu ion, which was in response to the core and was linear, could be observed. This suggests that the europium ion necessary for the light amplifying action is contained in the core portion alone.

### INDUSTRIAL APPLICABILITY

The resin composition for coating according to the present invention, which has the constitution described above, is excellent in solubility in solvents and can form uniform thin films with ease.

1. A cyclic ether copolymer obtained from a 1,3-dioxole ring structure-containing compound represented by the general formula (I) and an ethylenically unsaturated monomer: 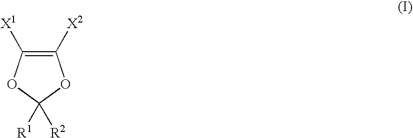
(wherein R¹ and R² are the same or different and each represents F, H, Cl or a perfluoroalkyl group containing 1 to 5 carbon atoms and X¹ and X² are the same or different and each represents F, H, Cl or —OR³, and R³ represents a perfluoroalkyl group containing 1 to 5 carbon atoms, provided that at least one of R¹ and R² is F or a perfluoroalkyl group containing 1 to 5 carbon atoms),
which copolymer has a glass transition point of 100 to 135° C. and an intrinsic.viscosity of 0.01 to 0.4 dl/g as determined at 35° C. in perfluoro-2-butyltetrahydrofuran.

2. A laminate comprising a substrate and a thin film formed on the substrate by using the cyclic ether copolymer according’ to claim 1,
wherein said thin film has a thickness not exceeding 1000 μm.

3. A resin composition for coating
which comprises the cyclic ether copolymer according to claim 1 and a solvent for dissolving said cyclic ether copolymer.

4. The resin composition for coating according to claim 3,
wherein the solvent for dissolving the cyclic ether copolymer is a solvent comprising at least one member selected from the group consisting of perfluoro-2-butyltetrahydrofuran, HCFC-225, CFC-113, perfluorotrialkylamines represented by the following general formula:
N(CₙF₂ₙ₊₁)₃ (wherein n represents an integer of 2 to 4) and fluorine-containing ethers represented by the general formula:
R⁵—O—R⁶
(wherein R⁵ is a straight or branched polyfluoroalkyl group containing 1 to 12 carbon atoms, which optionally contains an ether bond, and R⁶ is a straight or branched alkyl group containing 1 to 12 carbon atoms).

5. An optical material
which comprises the cyclic ether copolymer according to claim 1.

6. The optical material according to claim 5 which is a material for an optical waveguide.

7. An optical device having an optical waveguide
wherein said optical waveguide has a core formed by using the optical material according to claim 5 and/or a clad formed by using the optical material according to claim 5.

8. The optical device according to claim 7,
wherein the core is one formed by using the optical material according to claim 5 and, further, a rare earth metal ion.

9. A method of producing an optical device by using the cyclic ether copolymer according to claim 1,
which comprises
the step (1) of producing said cyclic ether copolymer,
the step (2) of preparing a resin composition for coating by using said cyclic ether copolymer and a solvent for dissolving said cyclic ether copolymer,
the step (3) of forming a lower clad on a substrate by using said resin composition for coating,
the step (4) of forming a core on said lower clad, and
the step (5) of forming an upper clad, by using said resin composition for coating, on said core obtained by said step (4) and formed on said lower clad.

10. The method of producing an optical device according to claim 9,
wherein the cyclic ether copolymer is produced by using a fluorine-free organic peroxide.

11. The method of producing an optical device according to claim 10,
wherein the fluorine-free organic peroxide is an organic peroxide comprising at least one member selected from the group consisting of oxyperesters, diacyl peroxides and peroxydicarbonates.

12. The method of producing an optical device according to claim 9,
wherein the core is one formed by using the cyclic ether copolymer and a rare earth metal ion.

13. The method of producing an optical device according to claim 9,
wherein the solvent for dissolving the cyclic ether-copolymer is a solvent comprising at least one member selected from the group consisting of perfluoro-2-butyltetrahydrofuran, HCFC-225, CFC-113, perfluorotrialkylamines represented by the following general formula: N(CₙF₂ₙ₊₁)₃ (wherein n represents an integer of 2 to 4) and fluorine-containing ethers represented by the following general formula:
R⁵—O—R⁶
(wherein R⁵ is a straight or branced polyfluoroalkyl group containing 1 to 12 carbon atoms, which optionally contains an ether bond, and R⁶ is a straight or branched alkyl group containing 1 to 12 carbon atoms).
